(19) United States
(12) Patent Application Publication
(10) Pub. No.: US 2025/0275564 A1
(43) Pub. Date: Sep. 4, 2025

(54) BINDER INCLUDING KONJAC PASTE AND OTHER COMPONENTS, SHAPE-RETAINED FOOD PRODUCT, AND METHOD FOR MANUFACTURING SHAPE-RETAINED FOOD PRODUCT

(71) Applicant: NINZIA INC., Hyogo (JP)

(72) Inventor: Masahiro Yoritama, Hyogo (JP)

(21) Appl. No.: 19/211,366

(22) Filed: May 19, 2025

Related U.S. Application Data
(63) Continuation of application No. PCT/JP2023/042254, filed on Nov. 24, 2023.

(30) Foreign Application Priority Data
Nov. 26, 2022 (JP) 2022-188790

(51) Int. Cl. A23L 29/244; A23L 25/00

(52) U.S. Cl. CPC A23L 29/244; A23L 25/30

(57) ABSTRACT

A binder including a konjac paste, a block food product, and a method for manufacturing a block food product contain no or less carbohydrates or lipids or affect the flavor or the taste of a binding target food material by a lesser degree are provided. A method (1) for manufacturing a block food product (5) includes preparing a binder (2) and a mixing target food material (3) containing a granular food material, mixing the binder (2) into the mixing target food material (3) and shaping a mixture of the binder (2) and the mixing target food material (3) into a block shape, and drying a food product (4) in the block shape.

### CROSS-REFERENCE TO RELATED APPLICATIONS

This application is a continuation application of International Patent Application No. PCT/JP2023/042254 filed on Nov. 24, 2023, which claims priority to Japanese Patent Application No. 2022-188790 filed on Nov. 26, 2022, the entire contents of which are incorporated by reference.

### STATEMENT REGARDING PRIOR DISCLOSURES BY THE INVENTORS OR JOINT INVENTORS UNDER 37 C.F.R. 1.77(b)(6)

The following publications are “inventor-originated disclosure(s)” within the exceptions defined in 35 U.S.C. 102 (b)(1). Applicant designates the following publications as a grace period publication in order to expedite examination of the application in accordance with 37 CFR 1.77 (b)(6) and MPEP 608.01 (a):
i) Japanese Patent Application Publication No. 2022-113668A published Aug. 4, 2022
ii) PR TIMES [online]. published Nov. 20, 2022 [retrieved on 26 Jan. 2024], Internet: URL: https://prtimes.jp/main/html/rd/p/000000061.000029701.html page 1, Konnyaku Food Tech, Decided to limit advance sale beta version of natural nut bar
iii) PR TIMES [online]. published Nov. 19, 2022 [retrieved on 26 Jan. 2024], Internet: URL: https://prtimes.jp/main/html/rd/p/000000060.000029701.html

Copies of the publications are provided in a concurrently filed Information Disclosure.

### BACKGROUND OF INVENTION

### Field of the Invention

The present invention relates to a binder including a konjac paste, etc., a shape-retained food product, and a method for manufacturing a shape-retained food product.

### Background Art

For calorie reduction or other purposes, a konjac paste or konjac has been mixed into another food material to provide springiness or increase the volume.

For example, Patent Literature 1 describes a method for manufacturing tofu konjac. The manufacturing method includes preparing a konjac paste using warm water, adding a low-viscosity tofu paste to the liquid konjac paste that is a mixture of a konjac powder and warm water before being thickened, and uniformly mixing the materials to obtain a resulting konjac paste.

Other examples of food products obtained by mixing konjac powder into another food material include konjac jelly and pasta containing konjac powder. Konjac powder is mixed to increase water retentivity, springiness, and dietary fiber as a nutrient. The shapes of these food products, or the shape retention or moldability of these food products, are seemingly not retained by glucomannan in the konjac powder. For example, the shape retention and moldability of konjac jelly are provided by gelatin, and those of pasta containing konjac powder is provided by wheat gluten.

Other examples of food materials obtained by processing konjac include pasta-resembling konjac noodles and vegan sashimi. Glucomannan, which contributes to shape-retaining and moldability, seemingly mostly causes water binding. Although another ingredient such as hijiki seaweed (black grains in typical konjac) or red pepper is added to some of those food materials, glucomannan seemingly does not cause binding of such solid food materials, but simply coagulate water for shape retention and moldability.

Known examples of viscous food binders include flour, sugar, honey, starch syrup, and chocolate.

### CITATION LIST

### Patent Literature

Patent Literature 1: Japanese Unexamined Patent Application Publication No. 2017-93400

Patent Literature 2: Japanese Unexamined Patent Application Publication No. 2022-113668

### SUMMARY OF INVENTION

### Technical Problem

As with known techniques, konjac is not frequently used to cause binding of food materials. Binders such as flour, sugar, honey, and starch syrup contain a large amount of carbohydrates, and chocolate contains a large amount of lipids. Flour, sugar, honey, starch syrup, or chocolate also adds its flavor or taste to the food materials to be bound.

One or more aspects of the present invention are directed to a binder including a konjac paste, a shape-retained food product, and a method for manufacturing a shape-retained food product that contain no or less carbohydrates or lipids or affect the flavor or the taste of the binding target food material by a lesser degree.

### Solution to Problem

(1) A binder according to a first aspect of the present invention is to be mixed into a food material and dried for retaining a predetermined shape of a food product. The binder includes a konjac paste at 0.5 to 5.0 wt %. The konjac paste is a swollen konjac refined powder.
(2) The binder may further include a coagulant added to the konjac paste to obtain a coagulant-containing konjac paste having a pH of 8 to 14.
(3) The coagulant-containing konjac paste may be a heat-treated konjac paste heated at 80 to 95° C. for more than or equal to 50 minutes and cooled.
(4) The binder may be frozen before being dried. The binder may include the konjac paste at 1.0 to 3.0 wt %.
(5) A method for manufacturing a shape-retained food product according to a second aspect of the present invention includes preparing the binder according to (1) described above and a food material into which the binder is to be mixed, mixing the binder into the food material and shaping a mixture of the binder and the food material into a predetermined shape, and drying the food material in the predetermined shape.
(6) A method for manufacturing a shape-retained food product according to a second aspect of the present invention includes preparing the binder according to (2) described above and a food material into which the binder is to be mixed, mixing the binder into the food material and shaping a mixture of the binder and the food material into a predetermined shape, and drying the food material in the predetermined shape.
(7) A method for manufacturing a shape-retained food product according to a second aspect of the present invention includes preparing the binder according to (3) described above and a food material into which the binder is to be mixed, mixing the binder into the food material and shaping a mixture of the binder and the food material into a predetermined shape, and drying the food material in the predetermined shape.
(8) A method for manufacturing a shape-retained food product according to a second aspect of the present invention includes preparing the binder according to (4) described above and a food material into which the binder is to be mixed, mixing the binder into the food material and shaping a mixture of the binder and the food material into a predetermined shape, freezing the food material in the predetermined shape, and drying the food material in the predetermined shape.
(9) In any one of such methods for manufacturing a shape-retained food product, the food material may contain a nut.
(10) A shape-retained food product according to a third aspect of the present invention includes a food material, and the binder according to (1) described above to be mixed into the food material. A mixture of the food material and the binder is shaped into a predetermined shape and dried.
(11) A shape-retained food product according to a third aspect of the present invention includes a food material, and the binder according to (2) described above to be mixed into the food material. A mixture of the food material and the binder is shaped into a predetermined shape and dried.
(12) A shape-retained food product according to a third aspect of the present invention includes a food material, and the binder according to (3) described above to be mixed into the food material. A mixture of the food material and the binder is shaped into a predetermined shape and dried.
(13) A shape-retained food product according to a third aspect of the present invention includes a food material, and the binder according to (4) described above to be mixed into the food material. A mixture of the food material and the binder is shaped into a predetermined shape and frozen before being dried.
(14) In any one of such shape-retained food products, the food material may contain a nut.

### Advantageous Effects

The technique according to the above aspects of the present invention allows binding of a food material with substantially no increase in carbohydrates and lipids. The technique allows binding of a food material without changing the taste and the flavor of the food materials.

### BRIEF DESCRIPTION OF THE DRAWINGS

FIG. 1 is a schematic flowchart of a method for manufacturing a block food product according to an embodiment of the present invention.

FIG. 2 is a schematic flowchart of a method for manufacturing a binder in FIG. 1.

FIG. 3 is a schematic diagram of a partially cut storage bag.

FIG. 4 is a schematic cross-sectional view of the storage bag in FIG. 3 storing a food material.

### DETAILED DESCRIPTION

### 1. Brief Description

### First Embodiment

A method for manufacturing a shape-retained food product containing a binder including a konjac paste, etc. (e.g., a konjac paste, a coagulant-containing konjac paste, or a heat-treated konjac paste) includes mixing the binder into a food material to be bound (a mixing target food material), shaping the mixture, and drying the mixture.

Binders including a konjac paste allow the manufacture of healthy foods (shape-retained food products) with lower carbohydrates than existing binders such as starch syrup, sugar, syrup, honey, or flour, with lower lipids than existing binders such as chocolate, and with more dietary fiber than the existing binders. For example, unlike chocolate and starch syrup that are heated before being mixed with the mixing target food material, a binder including a konjac paste, etc. can be mixed at room temperature, without being heated preliminarily.

The binder including a konjac paste, etc. has almost no taste, thus preserving the natural taste of the mixing target food material or allowing the food material to be seasoned freely.

The shape-retained food product manufactured using a binder including a konjac paste, etc. is less easily deformed at room temperature. Room temperature is, for example, around 25° C. The shape-retained food product is also less easily deformed at, for example, around 40° C., which is the typical outdoor temperature in Japan during summer.

A binder including a konjac paste, etc. (hereafter simply referred to as a binder) will be described later.

### 2. Detailed Description

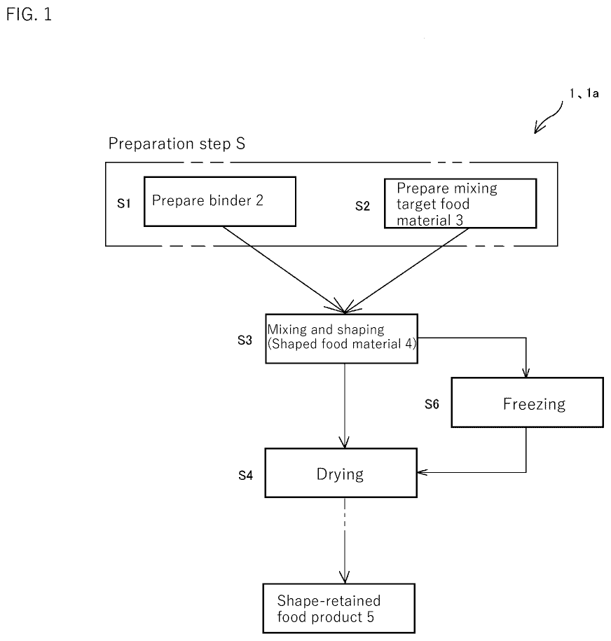

FIG. 1 is a schematic flowchart of a method for manufacturing a shape-retained food product according to an embodiment of the present invention (hereafter referred to as a manufacturing method).

A manufacturing method 1 shown in FIG. 1 includes preparation step S (refer to the two-dot-dash line), which includes step S1 of preparing a binder 2 and step S2 of preparing a mixing target food material 3, step S3 of mixing the binder 2 into the mixing target food material 3 and shaping the mixture to obtain a shaped food material 4, and drying step S4 of drying the shaped food material 4. Drying the shaped food material 4 completes the manufacture of a shape-retained food product 5.

### Step S1

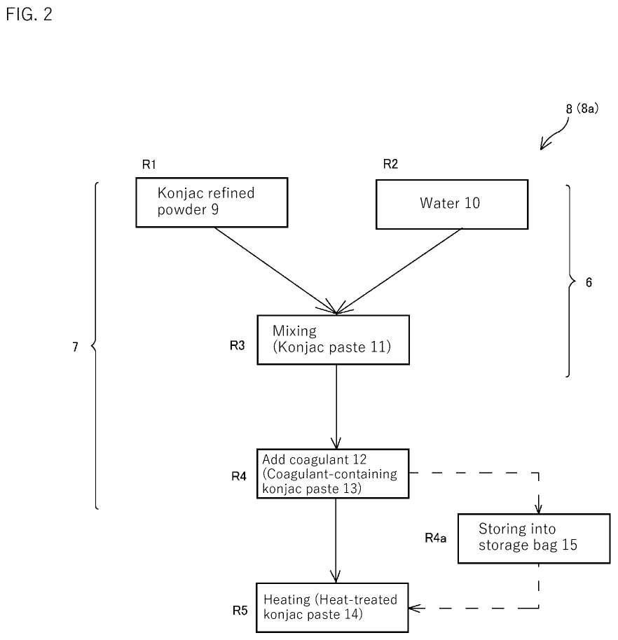

In step S1, the binder 2 is prepared. In the present embodiment, the binder 2 is any one of a konjac paste 11, a coagulant-containing konjac paste 13, or a heat-treated konjac paste 14 (refer to FIG. 2). These pastes will be described later.

The weight ratio between the binder 2 and the mixing target food material 3 is adjusted as appropriate substantially based on the concentration of the binder 2, the size of the mixing target food material 3, the degree of moisture penetration into the mixing target food material 3, drying time in the drying step (S4), and intended textures including appearance and mouthfeel of the shape-retained food product 5, although the weight ratio can change based on the characteristics of the mixing target food material 3.

### Step S2

In step S2, the mixing target food material 3 is prepared. In the present embodiment, examples of the mixing target food material 3 include a granular material, a seed-like solid, a gel such as gummy candy or jelly, and a food paste such as jam or simmered seaweed paste that has viscosity and no specific shape but can retain some part of its original shape without being placed in a container. The food material may be used in its original form, or in a cut or crushed form. The food material in a powder, grain, or piece form can be of any size. In addition, the food material may be a watery food material such as soy pulp or a food paste. For example, when the watery food material or the food paste is easily separable after being dried out, it may be used as the mixing target food material 3 with the manufacturing method according to an embodiment of the present invention.

### Mixing Target Food Material 3

Examples of the mixing target food material 3 include culinary nuts (for example, cereals) and/or nuts, soy pulp, (fresh, cooked fruit, or dried) fruits, (fresh, cooked, or dried) vegetables, confectionery such as gummies and jellies formed from, for example, juice set with gelatin, food grains such as wheat and sesame, legumes, watery food materials such as soy pulp, and food pastes such as jam, seaweed, and a simmered seaweed paste.

Other examples of the mixing target food material 3 to be added to adjust the taste of the food material may include water and seasonings. Seasonings include soy sauce, sweet sake, sake, vinegar, salt, pepper, and a mixture of red pepper and other spices. Seasonings other than those may also be added. Other food materials may also be added for seasoning, such as powder of milk, cheese, meat, or fish. Dietary fiber may further be added. The texture can be adjusted by the type or the amount of vegetable fiber. For example, inulin may be used as dietary fiber.

The mixing target food material 3 is not limited to particular materials.

The culinary nuts include edible fruits and seeds enclosed in a hard peel or nutshell. Nuts include nuts in the culinary nuts and some legumes generally accepted as nuts. The culinary nut content and the nut content to be used are adjusted as appropriate, without being limited to particular values. For example, a culinary nut and/or a nut is at least one selected from the group consisting of sesame, peanut, almond, walnut, cashew nut, and pecan nut.

When soy pulp as a watery food material or jam, seaweed, or a simmered seaweed paste as a food paste is used, the concentration or the amount of the binder 2 and the drying temperature or time in the drying step S4 may be adjusted based on the water content of the food material or the paste.

### Step S3

In step S3, the binder 2 is mixed into the mixing target food material 3, and the mixture is shaped. For example, a known device such as a mixing tank may be used for mixing. Although the temperature for mixing is not limited, the temperature may be around 25° C. as room temperature to uniformly and easily disperse the raw material. The temperature may be 5 to 70° C.

For example, unlike chocolate and starch syrup that are heated before being mixed with the mixing target food material 3, the binder 2 can be mixed at room temperature including 25° C., without being heated preliminarily. The binder 2 may be mixed at 5 to 70° C., specifically at 15 to 30° C., or more specifically at 20 to 27° C.

During mixing, milk and dairy products, a sweetener, fat or oil, an emulsifier, a stabilizer, a spice, or a coloring agent may or may not be added as appropriate. For example, a material such as a sweetener, sugar, honey, or a starch syrup may be added to enhance sweetness. To enhance viscosity, a material such as a thickener, flour, sugar, honey, or chocolate may be added. A thickener and a sweetener will be described later in detail.

In the present embodiment, for example, the food material is shaped into a block to be manually handleable. The food material may be shaped into a portable or visually attracting shape. Examples of portable shapes include a stick, a ball, and a bar. Examples of visually attracting shapes include a star, a moon, and a character. Examples of other shapes include a cone, a pyramid such as a quadrangular pyramid, and a rectangular prism including a cube. The food material may have any shape.

The food material is placed into a mold or a container as appropriate for shaping. The food material may be placed on, for example, baking paper or a plate in predetermined amounts without being placed in, for example, a container. The food material may be shaped by hand or with a mold before being placed on baking paper or a plate.

### Step S4

In step S4, the shaped food material 4 is dried. The shaped food material 4 may be heated, blown with hot air, freeze-dried, or deep-fried to be dried. The shape of the shaped food material 4 is retained through step S4. This shape retention maintains the shape of the food material without separation or a collapse. Separation or a collapse may be prevented to allow manually handling the shaped food material 4. For example, the shaped food material 4 may have its shape retained not to have, when held by hand, separation, a collapse, or a large amount of food material 4 sticking to the hand.

The drying temperature and the drying time are adjusted as appropriate for intended textures including appearance and mouthfeel or intended water content of the block food product 5.

For example, the drying temperature is set to 30 to 100° C. when the food material is dried with a food drier, set to 140 to 200° C. when deep-fried, set to 30 to 250° C. when dried with a convection oven, or set to about −30° C. when decompressed for freeze drying. For example, the drying time is 10 minutes to 24 hours. When using deep-frying, the drying time is 0.5 to 10 minutes. The drying temperature and the drying time may be set to other temperatures and times.

Example of Drying with Food Drier

For the mixing target food material 3 being a nut, the food material 4 shaped substantially into a block was placed in a drier and dried at 70° C. for 10 hours. This bound the materials appropriately and retained the block shape.

### Shape-Retained Food Product 5

The shape-retained food product 5, which includes the binder 2 including konjac to cause binding of the mixing target food material 3, is thus suitably used for a low-calorie food, a low-carbohydrate food, or a dietetic food. The shape-retained food product 5 is also suitably used for a nature-derived food with the original flavor, without the binder affecting the flavor or the taste of the material to be bound. The shape-retained food product 5 is also suitable for newly accepting a seasoning.

Examples of the shape-retained food product 5 retained in a block shape include a nut bar, an energy bar, a protein bar, and a cereal bar.

### Binder 2

FIG. 2 is a schematic flowchart of a method for manufacturing the binder 2. A manufacturing method 8 for manufacturing the binder 2 shown in FIG. 2 includes step R1 of preparing a konjac refined powder 9, step R2 of preparing water 10, step R3 of swelling the konjac refined powder 9, step R4 of adding an alkaline coagulant 12 to a swollen food material (konjac paste) 11 and kneading the mixture, step R5 of heating a food material (coagulant-containing konjac paste) 13 into which the coagulant is mixed while kneading the mixture, and step R6 of cooling the mixture to room temperature or lower. After the cooling in step R6, the heat-treated konjac paste 14 is obtained.

The konjac powder or the konjac refined powder is obtained by, for example, dry-grinding a konjac corm and removing starch, thus being constituted mostly by a water-soluble dietary fiber called konjac glucomannan. The konjac corm is, for example, a plant, and may refer to an underground portion.

The konjac paste is, for example, in a sol form, which is obtained by dissolving the konjac refined powder or the konjac powder in water. For example, konjac is in a gel form, which is obtained by adding an alkali coagulant into the konjac paste, and heating and coagulating the mixture.

### Step R1

Ten to thirty grams of konjac refined powder 9 is prepared.

### Step R2

One thousand milliliters of water 10 is prepared.

### Step R3

The water 10 is added to the konjac refined powder 9 to swell the konjac refined powder 9. The concentration of the konjac refined powder is 1 to 3 wt %. The konjac refined powder may be slowly swollen with cold water dissolved. The konjac paste 11 is obtained in this manner. Steps R1, R2, and R3 correspond to a manufacturing method 6 for manufacturing a konjac paste. The concentration of the konjac refined powder may be 0.5 to 5 wt %.

### Konjac Paste 11

The konjac paste 11 as the binder 2 enters into gaps or holes in the surface of the mixing target food material 3 and coagulates when dried in the drying step S4. The konjac paste 11 causes binding of the mixing target food material 3 by connecting small holes to each other (anchor effect).

### Step R4

The alkaline coagulant 12 is added to the konjac paste 11. The coagulant-containing konjac paste 13 is thus obtained. Steps R1, R2, R3, and R4 correspond to the manufacturing method 6 for manufacturing a konjac paste.

### Coagulant-Containing Konjac Paste 13

The coagulant-containing konjac paste 13 has a pH of 8 to 14 or may have a pH of higher than or equal to 11. For example, the coagulant-containing konjac paste 13 may have a pH of 13 to 14, or more specifically, 13.5 to 14. The coagulant-containing konjac paste 13 may slightly enhance the binding effect through partial gelation when heated in the drying step S4.

### Coagulant 12

Examples of the alkaline coagulant 12 include calcium oxide derived from calcined shells, hydroxide compounds such as sodium hydroxide, potassium hydroxide, calcium hydroxide, and magnesium hydroxide, carbonates such as sodium bicarbonate, sodium carbonate, potassium carbonate, calcium carbonate, and magnesium carbonate, sulfates such as calcium sulfate, potassium sulfate, sodium sulfate, and magnesium sulfate, and organic salts such as sodium citrate, sodium tartrate, sodium malate, sodium acetate, and sodium lactate. The alkaline coagulant 12 may be a mixture of two or more of these.

Examples of pH adjusters include adipic acid, citric acid, sodium citrate, glucono delta-lactone, gluconic acid, potassium gluconate, sodium gluconate, succinic acid, sodium succinate, disodium succinate, sodium acetate, DL-tartaric acid, L-tartaric acid, DL-potassium hydrogen tartrate, L-potassium hydrogen tartrate, DL-sodium tartrate, L-sodium tartrate, anhydrous potassium carbonate, sodium bicarbonate, sodium carbonate, carbon dioxide, lactic acid, potassium lactate, sodium lactate, glacial acetic acid, disodium pyrophosphate, fumaric acid, sodium fumarate, DL-malic acid, DL-sodium malate, phosphoric acid, dipotassium hydrogen phosphate, monopotassium phosphate, disodium hydrogen phosphate, monosodium phosphate, arginine, lysine, histidine, ornithine, and citrulline.

### Step R5

The coagulant-containing konjac paste 13 is heated at 60 to 90° C. for more than or equal to 50 minutes, or more specifically, at 80 to 90° C. for 50 to 120 minutes. The heating time varies based on the pH and the heating temperature. The coagulant-containing konjac paste 13 having a higher pH or heated at higher temperatures tends to have shorter heating time.

### Step R6

The coagulant-containing konjac paste 13 is then cooled to room temperature or lower. In the present embodiment, the coagulant-containing konjac paste 13 is cooled with water at 20° C. or lower.

### Heat-Treated Konjac Paste 14

A heat-treated konjac paste 14 obtained has a pH of 8 to 14.0, or specifically, about 8 to 9.0. For example, the heat-treated konjac paste 14 has a jam-like texture. The heat-treated konjac paste 14 is heated and cooled when being alkaline, thus seemingly gelled partially.

The heat-treated konjac paste 14 is heated when being alkaline in the heating step R5, thus being gelled partially. Heating in the drying step S4 may further cause partial gelation and enhance the binding effect.

### Example of Heat-Treated Konjac Paste 14

A konjac refined powder (10 to 30 g) was mixed into 1000 ml of water. The alkaline coagulant 12 was added to the mixture. The mixture was heated at a temperature of 60 to 90° C. for 50 to 120 minutes and then cooled at a temperature of about 20° C. to obtain the heat-treated konjac paste 14.

### Other Methods for Manufacturing Heat-Treated Konjac Paste 14

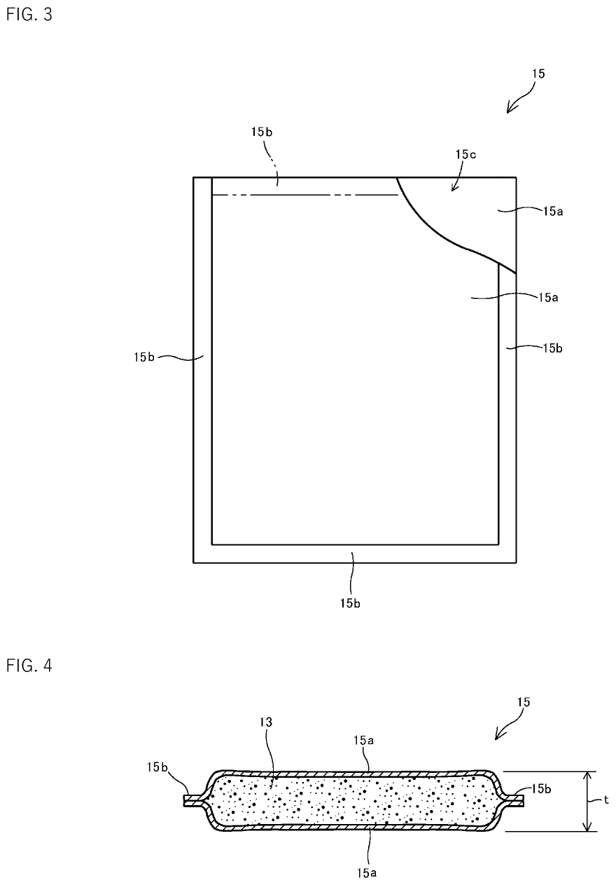

A manufacturing method 8a is almost the same as the manufacturing method 8 for manufacturing the heat-treated konjac paste 14. Like reference signs denote like or corresponding components. Such components will not be described in detail. The manufacturing method 8a includes, after addition of the coagulant, step R4a of storing the coagulant-containing konjac paste 13 into a storage bag 15 (refer to FIG. 3) of a plate shape with a substantially uniform thickness (refer to the dotted arrow). The coagulant-containing konjac paste 13 in the storage bag 15 is heated at temperatures higher than or equal to 80° C. for 60 to 100 minutes (R5), and cooled to about room temperature (R6).

The coagulant-containing konjac paste 13 flattened or thinned with the storage bag 15 can be entirely heated substantially uniformly. During heating, the coagulant-containing konjac paste 13 and the storage bag 15 can be sterilized. The coagulant-containing konjac paste 13 can be also be substantially uniformly cooled. Heating and cooling the coagulant-containing konjac paste 13 substantially uniformly allow efficient manufacturing of the heat-treated konjac paste 14.

### Storage Bag 15

FIG. 3 is a schematic diagram of a storage bag with a partial cut used in the manufacturing method 8a. The storage bag 15 shown in FIG. 3 includes two overlapping sheets 15a and a margin 15b resulting from sealing of the peripheries of the two sheets 15a by a predetermined width. For example, the storage bag 15 used in the manufacture has dimensions of 30×20 cm with a capacity of 920 ml. The width of the margin 15b is 0.8 to 1 cm. The width of the margin 15b may be 0.2 to 2 cm, or specifically, about 0.5 to 1.5 cm.

The storage bag 15 has an upper end (top in the drawing) unsealed as an opening 15c. After the coagulant-containing konjac paste 13 is inserted through the opening 15c, the opening 15c is sealed to be the margin 15b (refer to the two-dot-dash line). After being enclosed in the storage bag 15, the coagulant-containing konjac paste 13 is shaped into a flat plate with a substantially uniform thickness (refer to t in FIG. 4). The storage bag 15 with the margin 15b is likely to retain the flat plate shape. The thickness tis 0.5 to 5 cm, or specifically, 1 to 3 cm.

### 3. Other Embodiments

Other embodiments and modifications of the manufacturing method 1 according to one or more embodiments of the present invention will now be described. The manufacturing methods according to other embodiments and modifications are almost the same as the above manufacturing method 1. Like reference signs denote like or corresponding components. Such components will not be described in detail.

### Second Embodiment

Referring back to FIG. 1, FIG. 1 shows a manufacturing method according to another embodiment (hereafter referred to as a second manufacturing method). A second manufacturing method 1a shown in the figure includes a freezing step (step S6) between the mixing and shaping step (step S3) and the drying step (step S4).

### Step S6: Freezing Step

The freezing temperature is −5 to −40° C., or specifically, −5 to −20° C. In the present embodiment, the freezing temperature is about −18° C. The freezing time is, for example, more than or equal to two hours, or specifically, more than or equal to eight hours, or an overnight. When frozen in a freezer at about −18° C. for more than or equal to eight hours, the shaped food material 4 coagulates or gels further steadily.

### Characteristics of Heat-Treated Konjac Paste 14

The coagulated konjac paste 11 is commonly referred to as konjac. The heat-treated konjac paste 14 has different characteristics from the konjac paste 11 and konjac. The heat-treated konjac paste 14 is in a paste form at non-refrigerated temperature. The heat-treated konjac paste 14 coagulates or gels when frozen, and remains coagulating or gelling when defrosted. The heat-treated konjac paste 14 including a larger amount of konjac refined powder 9 tends to coagulate or gel further. This tendency has relations to the capability of causing binding of a food material.

For example, when the procedure from the freezing step S6 to the drying step S4 cannot be followed due to, for example, lack of facilities, a larger amount of heat-treated konjac paste 14 may be used in advance.

When the procedure from the freezing step S6 to the drying step S4 can be easily followed, a smaller amount of the heat-treated konjac paste 14 may be used.

Example of Deep-Frying after Freezing

For the mixing target food material 3 being a nut, 50 g of the food material 4 (containing 20 g of the binder) shaped substantially into a block is frozen and then deep-fried at about 170° C. for six minutes. This forms a nut bar. A shaped food material 4 deep-fried for two minutes had a tendency of its inside water evaporating by a smaller amount. A shaped food material 4 deep-fried for eight minutes had a tendency of burned easily.

### First Modification

A modification of the manufacturing methods 1 and 1a will be described below. In a first modification, a sweetener is added to the block food product 5 to increase sweetness. The sweetener may be added in step S1 of preparing the binder 2, in step S2 of preparing the mixing target food material 3, or in the mixing step S3 (refer to FIG. 1).

A sweetener may be preliminarily mixed into the binder 2. The sweetener may be mixed at any time until the konjac paste 11, the coagulant-containing konjac paste 13, or the heat-treated konjac paste 14 is complete. The sweetener may be mixed into the heat-treated konjac paste 14 after the heating step R5.

Sweeteners are broadly classified either as carbohydrate-based sweeteners or non-carbohydrate-based sweeteners. Non-carbohydrate sweeteners include natural and synthetic sweeteners.

Examples of carbohydrate-based sweeteners include sugar, starch-based sugar, sugar alcohol, and other sugars. Starch-based sugar may be glucose, fructose, maltose, starch syrup, isomerized sugar, isomaltooligosaccharide, or trehalose. Sugar alcohol may be sorbitol, mannitol, maltitol, reduced starch syrup, reduced palatinose, xylitol, or erythritol. Other sugars may be fructooligosaccharide, galactooligosaccharide, xylooligosaccharide, lactosucrose, soy oligosaccharide, raffinose, or lactose.

Natural sweeteners as non-carbohydrate-based sweeteners include stevia, licorice (glycyrrhizin), and a monk fruit sweetener. Synthetic sweeteners as non-carbohydrate-based sweeteners include saccharin, aspartame, acesulfame K, and sucralose.

Any of these components may be obtained by mixing a nature-derived food.

A sweetener with lower energy than sugar may be used. Sugar may be supplementally used. A mixture of any of the above sweeteners may be used as a sweetener.

A carbohydrate-based sweetener may be used as a sweetener in place of a non-carbohydrate-based sweetener or sugar. A non-carbohydrate-based sweetener may be used as a sweetener in place of a carbohydrate-based sweetener.

For example, when the sugar to be used to achieve intended sweetness is entirely or partially reduced, the sweetness lost by the sugar reduction is supplemented with an adjusted non-carbohydrate-based sweetener. The sweetener in this case may have a lower calorie or lower carbohydrates than sugar used to obtain intended sweetness.

The sweetener and the konjac refined powder 9 may be blended to supplement the binding force reduced by the sugar reduction.

The sweetener and the konjac refined powder 9 may be blended to supplement the viscosity reduced by the sugar reduction.

### Second Modification

A modification of the manufacturing methods 1 and 1a will be described below. In a second modification, a thickener is added to facilitate molding of the food material 4 shaped in a block or to cause binding of the mixing target food material 3. The step of mixing the thickener is performed in the same sequence as in the first modification.

### Thickener

Examples of a thickener include plant-derived stabilizers (polysaccharide thickener), animal-derived stabilizers, and synthetic stabilizers. Plant-derived stabilizers include carrageenan, guar gum, locust bean gum, (microcrystalline) cellulose, pectin, starch, and gum Arabic. Animal-derived stabilizers include gelatin, casein, casein-Na, and sodium caseinate. Synthetic stabilizers include carboxymethyl cellulose (CMC) and methyl cellulose. When a thickener is added, the amount of the binder 2 may be reduced.

These components may be obtained by mixing nature-derived food materials. A food material rich in fiber may be used. For example, powdered kelp or seaweed may be mixed (refer to eighth example).

### Third Modification

A modification of the manufacturing methods 1 and 1a will be described below. In a third modification, a flavor is added to the food material 4 shaped in a block. The step of mixing the flavor is performed in the same sequence as in the first and second modifications.

The flavor is used to reduce konjac smell. The konjac smell is seemingly caused by remaining trimethylamine mainly contained in the peel and by alkaline smell caused by coagulation.

The flavor may be obtained by mixing nature-derived food materials such as juice of lemons, apples, grapes, or oranges.

When the sweetener, the thickener, or the flavor to be mixed in the coagulant-containing konjac paste 13 and the heat-treated konjac paste 14 according to the first, second, and third modifications are acid, the total pH is to be adjusted to be alkaline. The sweetener, the thickener, or the flavor may be added to the heat-treated konjac paste 14 after the heating step R5 to avoid interference with gelation in the heating step R5.

Two or more of the first, second, and third modifications may be combined as appropriate.

### 4. Examples of Food Product 5 Retained in Block Shape

### First Example: Nut Bar, Heat-Treated Konjac Paste 14

In a first example described below, a bound food product 5 retained in a block shape (hereafter referred to as a block food product 5) contained the heat-treated konjac paste 14. A nut bar was manufactured as the block food product 5 with the above second manufacturing method 1a.

Using a home-use mixer, almonds, cashew nuts, and walnuts were crushed into coarse pieces to obtain 400 g of a food material containing mixed nuts (mixing target food material 3) in total. Into the obtained food material containing mixed nuts, 300 g of the heat-treated konjac paste 14 with 1.5 wt % of the konjac refined powder 9 was mixed. The mixture was shaped and frozen at about −18° C. The mixture was then defrosted at room temperature of 15° C. for about six hours. After being defrosted, the mixture was deep-fried at 170° C. for six minutes. The food material containing mixed nuts was bound appropriately to be the block food product 5.

### Second Example: Nut Bar, Heat-Treated Konjac Paste 14

A block food product 5 according to a second example will be described below. The second example is almost the same as the first example, and the same components will not be described.

In the second example, almonds, cashew nuts, walnuts, and peanuts each in an amount of 100 g were crushed into coarse pieces to prepare 400 g of a food material containing mixed nuts (mixing target food material 3) in total. For example, almonds, cashew nuts, and peanuts were each divided into about 16 pieces, and each walnut was divided into four pieces.

Of the prepared food material containing the mixed nuts, 350 g was flattened and dried in a convection oven at 100° C. for 100 minutes. The dried food material was cut into pieces of a hand-held size.

The obtained nut bar was dried insufficiently, with a center portion on the back surface left undried. The heat-treated konjac paste 14 is to be evenly dried.

### Third Example: Nut Bar, Heat-Treated Konjac Paste 14

A block food product 5 according to a third example will be described below. The third example is almost the same as the first example, and the same components will not be described.

A food material (mixing target food material 3) containing mixed nuts including 30 g of peanuts each divided into 16 pieces, 15 g of walnuts each divided into four pieces, 5 g of pumpkin seeds, and 7 g of almonds each divided into four pieces, 7 g of Lakanto S Granule manufactured by Saraya Co., Ltd. to serve as a sweetener, and 30 g of the heat-treated konjac paste 14 with 1.5 wt % of the konjac refined powder 9 were prepared and then mixed together. The mixture of the food materials was placed in a madeleine mold and heated in an oven at 110° C. for 60 minutes. The mixture was then removed from the madeleine mold, turned over, and heated under the same conditions. The obtained nut bar was bound appropriately.

When the heat-treated konjac paste 14 was reduced from 30 g to 20 g, the food material containing mixed nuts collapsed with a weak force. Thus, the amount of heat-treated konjac paste 14 is to be greater than or equal to 30 g.

### Fourth Example: Nut Bar, Heat-Treated Konjac Paste 14

A block food product 5 according to a fourth example will be described below. The fourth example is almost the same as the first example, and the same components will not be described.

A food material (mixing target food material 3) containing mixed nuts including 60 g of peanuts, 30 g of walnuts, 10 g of pumpkin seeds, and 14 g of almonds, 7 g of Lakanto S Granule manufactured by Saraya Co., Ltd. to serve as a sweetener, 1 g of a seasoning such as salt, and 60 g of the heat-treated konjac paste 14 with 1.5 wt % of the konjac refined powder 9 were prepared and then mixed together. The mixture of the food materials was placed in a mold and heated in a convection oven at 110° C. for 60 minutes with blowing drying air. The mixture was then removed from the mold, turned over and heated under the same conditions. The obtained nut bar was bound appropriately.

### Fifth Example: Nut Bar, Heat-Treated Konjac Paste 14

A block food product 5 according to a fifth example will be described below. The fifth example differs from the fourth example in that the drying condition was changed to heating at 110° C. for 40 minutes in a convection oven. Other conditions remain unchanged. The nut bar according to the fifth example contained some water of the heat-treated konjac paste 14.

This example indicates that drying the heat-treated konjac paste 14 involves a sufficiently long drying time.

### Sixth Example: Nut Bar, Konjac Paste 11

A block food product 5 according to a sixth example will be described below. The sixth example differs from the fourth example in that the konjac paste 11 with 1.5 wt % of the konjac refined powder 9 is used in place of the heat-treated konjac paste 14. Other conditions remain unchanged. The obtained nut bar was bound.

### Seventh Example: Nut Bar, Coagulant-Containing Konjac Paste 13

A block food product 5 according to a seventh example will be described below. The seventh example differs from the fourth example in that 60.2 g of the coagulant-containing konjac paste 13 with 1.5 wt % of the konjac refined powder 9 is used in place of the heat-treated konjac paste 14. The coagulant-containing konjac paste 13 contains 0.2 g of calcium carbonate as a coagulant. Other conditions remain unchanged. The obtained nut bar was bound.

### Eighth Example: Nut Bar, Kelp Powder, Coagulant-Contained Konjac Paste 13

A block food product 5 according to an eighth example will be described below. The eighth example differs from the fourth example in that 60 g of mixed nuts (mixing target food material 3), 25 g of the heat-treated konjac paste 14 with 1.5 wt % of the konjac refined powder 9, and 0.5 g of the konjac powder were prepared and mixed together. The mixture of the food materials was placed in a mold and heated in a convection oven at 110° C. for 60 minutes with blowing drying air. The mixture was then removed from the mold, turned over, and heated under the same conditions. The obtained nut bar was bound appropriately. The heat-treated konjac paste 14 was reduced by an amount corresponding to the amount of kelp powder used as a thickener.

### 5. Others

(1) The konjac refined powder 9 used in FIG. 2 may be dried corm slices. In this case, the dried corm slices are ground before being processed.
(2) The block food material 4 may be rapidly heated for drying.
(3) Roasting or grilling may be performed in the drying step S4 shown in FIG. 1.
(4) Components described in the modifications, embodiments, or others may be combined as appropriate.
(5) The heat-treated konjac paste 14 is estimated to be gelling partially to have long chains entangled to form links, with the space between the entangled chains filled with water. When ice crystals form when the heat-treated konjac paste 14 is frozen, the chains pushed off by the ice crystals are densely bound and remain densely bound after being defrosted. This seemingly has relations to the capability of causing binding of a food material.

### 6. Overview

(1) The binder 2 described above is mixed into the food material 3 and dried for retaining a predetermined shape of the food material shaped after mixing. The binder 2 includes the konjac paste 11 at 0.5 to 5.0 wt %. The konjac paste 11 is the konjac refined powder 9 being swollen.

The konjac paste 11 as the binder 2 enters into gaps or holes in the surface of the mixing target food material 3 and coagulates when dried. The konjac paste 11 causes binding of the mixing target food material 3 by connecting small holes to each other (anchor effect).

The binder allows the manufacture of healthy foods (block food products 5) with lower carbohydrates than existing binders such as starch syrup, sugar, syrup, honey, or flour, with lower lipids than existing binders such as chocolate, and with more dietary fiber than existing binders.

The binder including a konjac paste, etc. has almost no taste, thus preserving the natural taste of the mixing target food material or allowing the food material to be seasoned freely.

The block food product manufactured by using a binder including a konjac paste, etc. is less easily deformed at room temperature. Room temperature is, for example, around 25° C. The block food product is also less easily deformed at, for example, around 40° C., which is the typical outdoor temperature in Japan during summer.
(2) Such a binder further includes a coagulant added to the konjac paste to obtain a coagulant-containing konjac paste having a pH of 8 to 14. The coagulant-containing konjac paste may enhance the binding effect through partial gelation when heated in drying.
(3) The coagulant-containing konjac paste is a heat-treated konjac paste heated at 80 to 95° C. for more than or equal to 50 minutes and cooled. The heat-treated konjac paste is heated when being alkaline, thus being gelled partially. Heating in drying may cause further gelation to enhance binding effect.
(4) The binder may be frozen before being dried, and the binder includes the konjac paste at 1.0 to 3.0 wt %.
(5, 6, 7, 10, 11, 12) The above manufacturing method 1 (1a) for manufacturing a block food product includes preparing the binder 2 described above (1, 2, 3) and the mixing target food material 3, mixing the binder 2 into the mixing target food material 3 and shaping the mixture into a block, and drying the block food material 4.
(8, 13) The above manufacturing method 1 (1a) for manufacturing a block food product includes preparing the binder 2 described above (4) and the mixing target food material 3, mixing the binder 2 into the mixing target food material 3 and shaping the mixture into a block, freezing the block food material, and drying the block food material 4.

The above manufacturing method 1 (1a) allows the manufacture of healthy block food products 5 with lower carbohydrates, lower lipids, and more dietary fiber.

The binder 2 including a konjac paste, etc. has almost no taste, thus preserving the natural taste of the binding target food material 3 and allowing the food material to be seasoned freely.

The block food product 5 manufactured by using the binder 2 including a konjac paste, etc. is less easily deformed at room temperature. Room temperature is, for example, around 25° C. The shape-retained food product is also less easily deformed at, for example, around 40° C., which is the typical outdoor temperature in Japan during summer.

For example, unlike chocolate and starch syrup that are heated before being mixed with the mixing target food material 3, the binder 2 including a konjac paste, etc. can be mixed at room temperature, without being heated preliminarily.

Freezing can reliably coagulate or gel the shaped food material 4. The shaped food material 4 can remain coagulating or gelling after being defrosted.
(9, 14) In the manufacturing method 1 (1a) for manufacturing such a block food product, the mixing target food material 3 contains a nut. This allows the manufacture of, for example, a nut bar as confectionery or an emergency food ration.

### REFERENCE SIGNS LIST

1 method for manufacturing block food product
2 binder
3 mixing target food material
4 shaped food material (food material shaped in block)
5 shape-retained food product (food product retained in block shape)
6 method for manufacturing binder (konjac paste)
7 method for manufacturing binder (coagulant-containing konjac)
8 method for manufacturing binder (heat-treated konjac)
8a another method for manufacturing binder (heat-treated konjac)
9 konjac refined powder
10 water
11 konjac paste
12 alkaline coagulant
13 coagulant-containing konjac paste
14 heat-treated konjac paste
15 storage bag
15a sheet
15b margin
15c opening

1. A binder to be mixed into a food material and dried for retaining a predetermined shape of a food product, the binder comprising:
a konjac paste at 0.5 to 5.0 wt %, the konjac paste being a swollen konjac refined powder.

2. The binder according to claim 1, further comprising:
a coagulant added to the konjac paste to obtain a coagulant-containing konjac paste having a pH of 8 to 14.

3. The binder according to claim 2, wherein
the coagulant-containing konjac paste is a heat-treated konjac paste heated at 80 to 95° C. for more than or equal to 50 minutes and cooled.

4. The binder according to claim 3, wherein
the binder is frozen before being dried, and
the binder comprises the konjac paste at 1.0 to 3.0 wt %.

5. A method for manufacturing a shape-retained food product, the method comprising:
preparing the binder according to claim 1 and a food material into which the binder is to be mixed;
mixing the binder into the food material and shaping a mixture of the binder and the food material into a predetermined shape; and
drying the food material in the predetermined shape.

6. A method for manufacturing a shape-retained food product, comprising:
preparing the binder according to claim 2 and a food material into which the binder is to be mixed;
mixing the binder into the food material and shaping a mixture of the binder and the food material into a predetermined shape; and
drying the food material in the predetermined shape.

7. A method for manufacturing a shape-retained food product, comprising:
preparing the binder according to claim 3 and a food material into which the binder is to be mixed;
mixing the binder into the food material and shaping a mixture of the binder and the food material into a predetermined shape; and
drying the food material in the predetermined shape.

8. A method for manufacturing a shape-retained food product, the method comprising:
preparing the binder according to claim 4 and a food material into which the binder is to be mixed;
mixing the binder into the food material and shaping a mixture of the binder and the food material into a predetermined shape;
freezing the food material in the predetermined shape; and
drying the food material in the predetermined shape.

9. The method according to claim 5, wherein
the food material contains a nut.

10. A shape-retained food product, comprising:
a food material; and
the binder according to claim 1 to be mixed into the food material,
wherein a mixture of the food material and the binder is shaped into a predetermined shape and dried.

11. A shape-retained food product, comprising:
a food material; and
the binder according to claim 2 to be mixed into the food material,
wherein a mixture of the food material and the binder is shaped into a predetermined shape and dried.

12. A shape-retained food product, comprising:
a food material; and
the binder according to claim 3 to be mixed into the food material,
wherein a mixture of the food material and the binder is shaped into a predetermined shape and dried.

13. A shape-retained food product, comprising:
a food material; and
the binder according to claim 4 to be mixed into the food material,
wherein a mixture of the food material and the binder is shaped into a predetermined shape and frozen before being dried.

14. The shape-retained food product according to claim 10, wherein
the shape-retained food product is a block food product, and
the food material contains a nut.

15. The method according to claim 7, wherein
the food material contains a nut.

16. The method according to claim 8, wherein
the food material contains a nut.

17. The shape-retained food product according to claim 11, wherein
the shape-retained food product is a block food product, and
the food material contains a nut.

18. The shape-retained food product according to claim 12, wherein
the shape-retained food product is a block food product, and
the food material contains a nut.

19. The shape-retained food product according to claim 13, wherein
the shape-retained food product is a block food product, and
the food material contains a nut.
